(19) United States
(12) Patent Application Publication
(10) Pub. No.: US 2002/0033172 A1
(43) Pub. Date: Mar. 21, 2002

(54) Bar-grill-cooler

(76) Inventor: Juan Manuel Medina Ruiz, Tijuana Baja, CA (US)

Correspondence Address: JUAN MANUEL MEDINA RUIZ, 4492 CAMINO DE LA PLAZA # 1220, SAN YSIDRO, CA, 92173-3097, US

(21) Appl. No.: 09/853,423

(22) Filed: May 10, 2001

Related U.S. Application Data
(60) Provisional application No. 60/204,430, filed on May 13, 2000.

(51) Int. Cl. F24B 3/00; A47J 37/00; F24C 15/10; F24C 5/00; F24C 15/08

(52) U.S. Cl. 126/25 R; 126/37 R; 126/39 B; 126/50

(57) ABSTRACT

A combination of a table bar, grill and cooler all blended together in a single apparatus. The grill (19) is equipped to work with either a gas burner or charcoal, and comes equipped with a lid. A container for use with ice is provided to work as a cooler (23) where drinks may be placed for chilling. A wine rack (17) and gas tank (35) compartment is provided as well as a storage area with service door (16). Additionally two umbrella holders (14, 15) are place on either side to allow the use of umbrella shades. Adjustable legs (27) are provided for leveling the apparatus with the floor. It is composed of five major elements: grill section, cooler section and the three tabletops and it is assembled using only 11 bolts. A variety of aesthetic designs and finishes can be incorporated in the faceplates to create a unique presentation.

### BACKGROUND

1. Field of the Invention

This invention relates to outdoor grilling, coolers and patio furniture.

2. Description of the Prior Art

Current barbecuing apparatuses are both too big and waste space and functionality or are too small and don't offer all the necessary functions. Many others don't offer easy maintenance, do not have an aesthetic presentation or are too bulky. Yet others are fixed in their position and don't offer the option of relocating. Many of these apparatuses have a high production cost.

This invention is the outcome in the attempt to address the problems of combined functionality, presentation, bulkiness, mobility and novelty of a new concept.

Various types of grills with combined table have been previously invented. U.S. patents, Des. 350,045 to Stuart (1994), Des. 253,931 to Devisher (1980), Des. 361,467 to Kabayama (1995), and Des. 286,002 to Brix (1986), are similar to each other, they have the advantage of offering a table structure combined with a grill, but they are very unstable and they do not offer an aesthetic presentation and only have the function of a grill and small table area. Others have very irregular, voluminous forms that are bulky like U.S. Pat. No. 4,840,128 to McFarlane et al. (1989) and U.S. Pat. No. 4,616,626 to Kwon Soon (1986) and additionally do not separate from the same idea of attempting to provide a service area combined with a grill. Others like U.S. Pat. No. 6,065,466 to Banal (1998) has a design that is stable, have various service functions, and are easy to assemble. It has an appealing form and is adaptable to small spaces. The drawbacks to this design are that you need to rearrange the accessories to the function that you wish to use, you may only use one function at a time, and it is either a cooler or a grill. Only a limited amount of people may sit around its table, it has a very similar appearance to other current designs (like U.S. Patent Des. 286,002 to Brix). Dust and other harmful health hazards may accumulate in the base of the pedestal, which require constant disassembly of the apparatus for cleaning. A person may not sit too close to the table do to the heat radiation produced by the grill and additionally the cooking area is very small and does not provide a space to store it's own accessories.

### OBJECTS AND ADVANTAGES

Accordingly, several objects and advantages of my invention are: This new design offers all the service function at the same time, grill, bar and cooler. You do not need to disassemble the apparatus to switch to another function. My invention has all the necessary services that are needed in a family or friends reunion and additionally it has space for storage of accessories and barbecuing utensils and if so desired a salad bowl may be placed instead of the cooler. The apparatus is composed of five major elements: grill section, cooler section and the three tabletops. This design allows for the five major components to be handled very easily by two persons.

My invention has an innovative design that does not look like anything on the market today. This design is balanced with respect to size and proportion; it has an elegant form and allows for people to join the services from any side of the apparatus and has a special area for the chef or host. It can easily have eight to ten persons sitting around it. The invention has a very flexible design that allows any type of finishes to be applied on its faceplates. Additionally it provides two holders for umbrellas to provide shade. It has a very easy fabrication process and easy transportation.

### DRAWING FIGURES

In the drawings, closely related figures have the same number.

FIG. 1 shows an isometric drawing of the whole assembled apparatus, showing the position of the bar, cooler and grill, and ancillary components.

FIG. 2 is an exploded view of the apparatus detailing of the structural and aesthetic components of the invention. Each of the main elements are depicted with their corresponding placement.

FIGS. 3, 4, and 5 show details of the three tabletop areas, grill area, cooler area, and bar respectively.

FIGS. 6, 7, 8 and 9 show the front, rear, right and left views respectively of the apparatus.

FIG. 10 is section view of the apparatus.

FIG. 11 shows a detail of the joint between the two major components of the apparatus.

FIG. 12 shows the top view of the apparatus.

FIG. 13 shows a detail of a typical leg

FIG. 14 section of a typical leg

Reference Numerals in Drawings

1 Metal frame for grill section

2 Metal frame for cooler section

3 Grill section tabletop

4 Cooler section tabletop

5 Table bar

6 Cooler section end faceplate

7 Rear faceplate of cooler section with wine rack and access

8 Rear faceplate of grill section with access door

9 Grill section end faceplate

10 Front faceplate of grill section

11 Front faceplate of cooler section

12 Rear joint plate

13 Front joint plate

14 Umbrella holder for grill section

15 Umbrella holder for cooler section

16 Grill underside access door

17 Wine rack

18 Cutout on grill tabletop for grill bowl

19 Grill bowl

20 Grill cover

21 Umbrella holder hole (grill section)

22 Cutout on cooler tabletop for cooler compartment

23 Cooler compartment

24 Umbrella holder cutout

25 Umbrella holder hole (cooler section)

26 Joint bolts and nuts

27 Support leg

28 Adjustable bolt

29 Nut guide

30 Metallic L-shape metal

31 Typical skeletal frame

32 Opening for access

33 Resin cover

34 Resin cover holder bolt

35 Gas tank

36 Joint plate weld

### SUMMARY

This invention is a cooking apparatus that unites all the essential functions of the traditional barbecuing requirements: a barbecuing grill, an ice holder and drink cooler, and utility tabletops for guests. Additionally it provides a wine rack, umbrella shades and storage space for accessories.

### DESCRIPTION

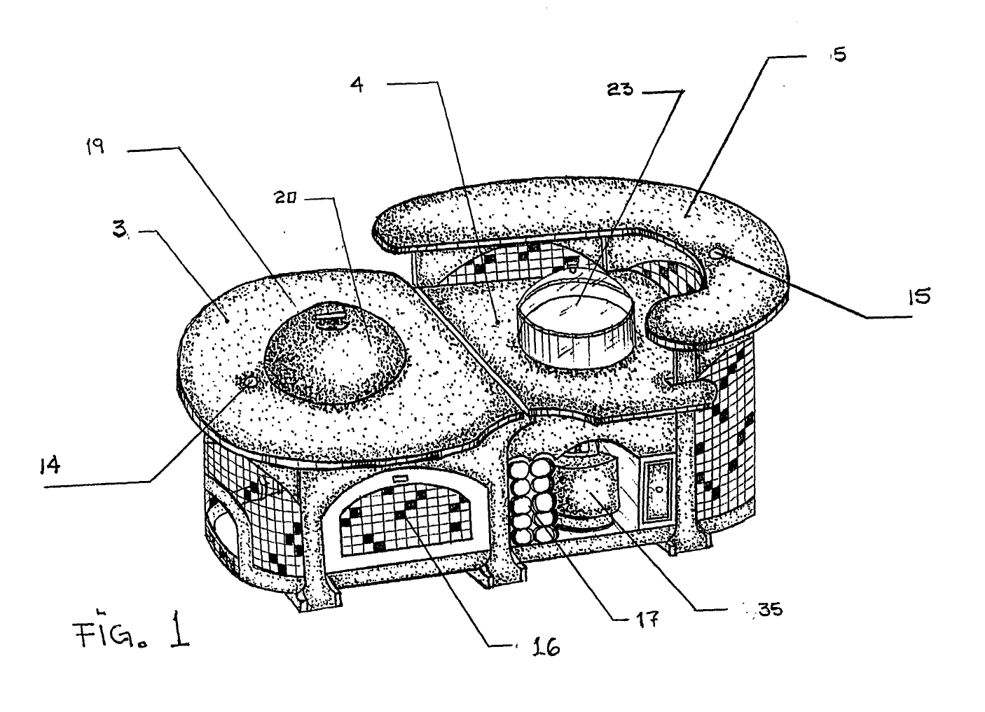

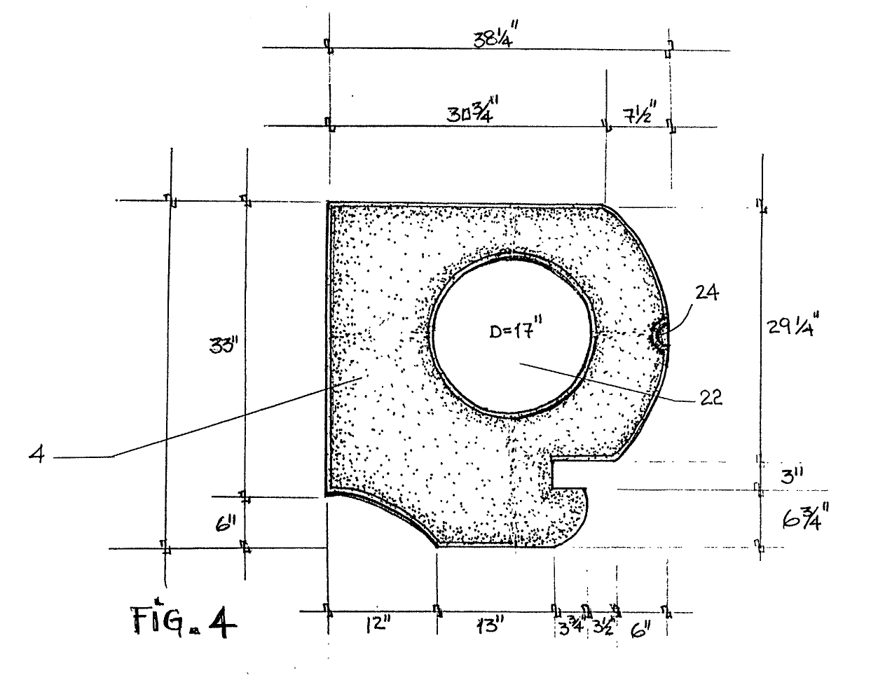

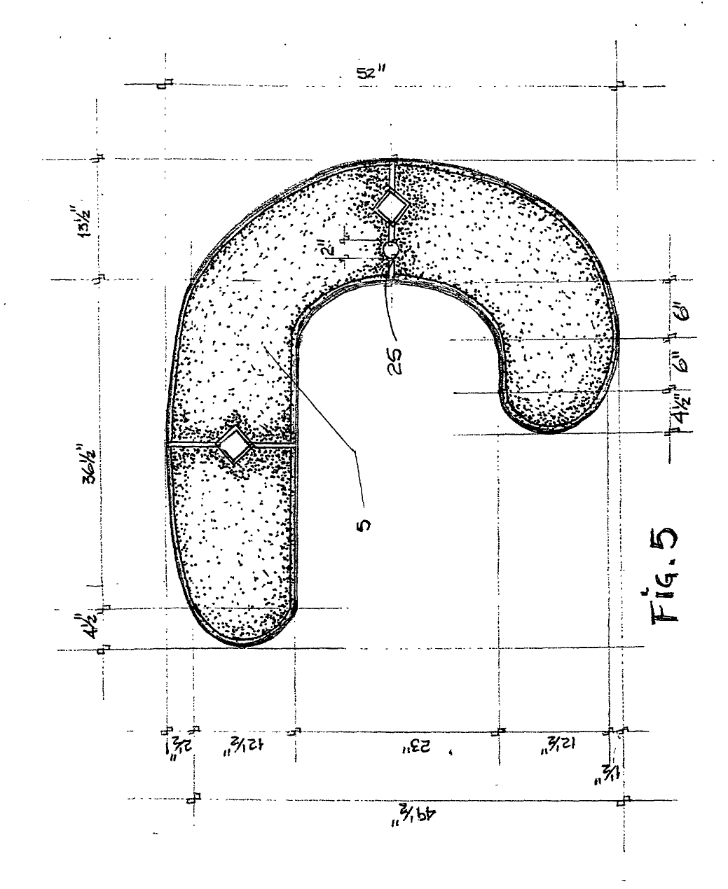

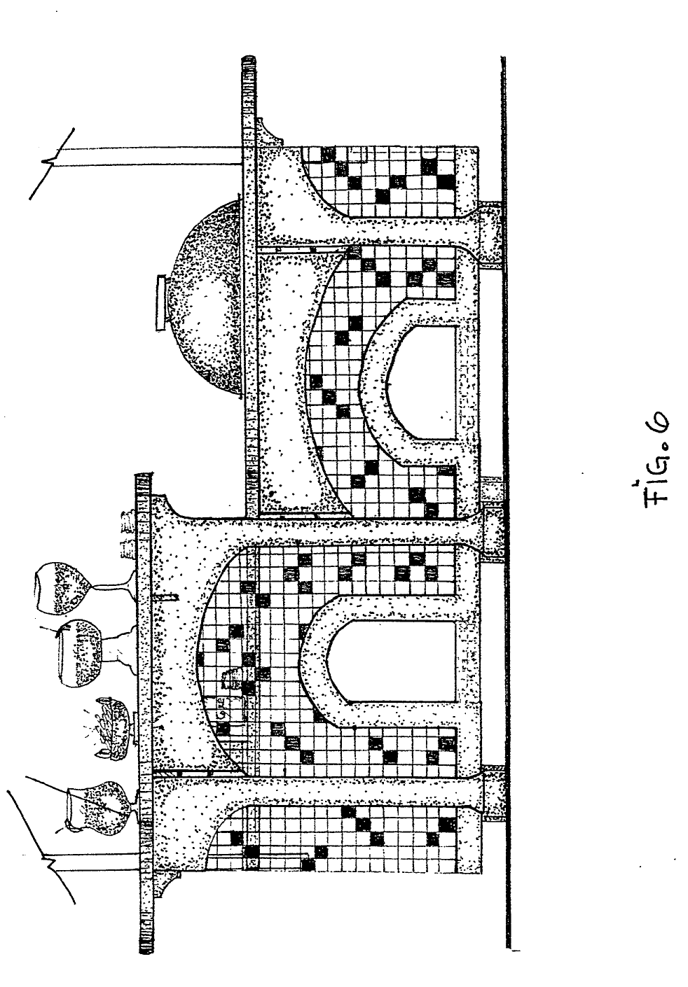

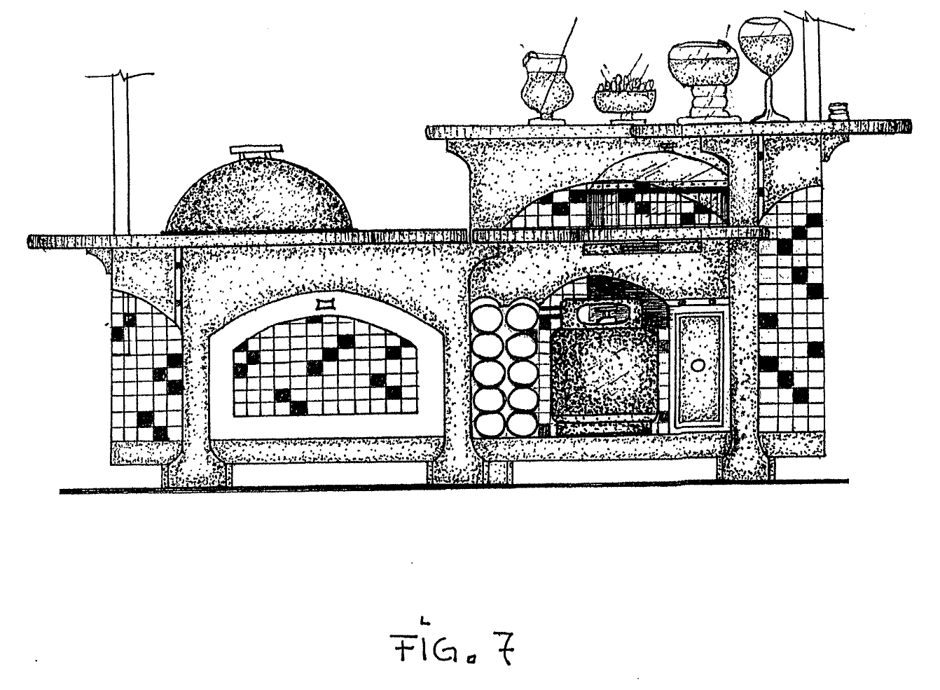

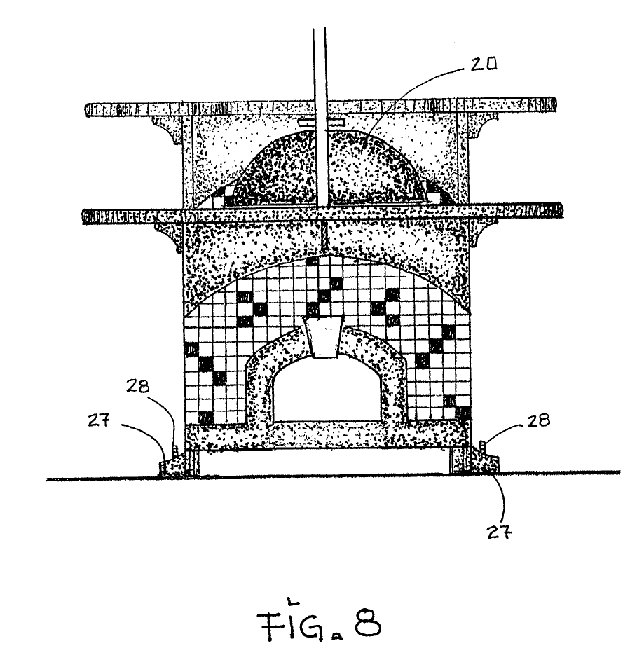

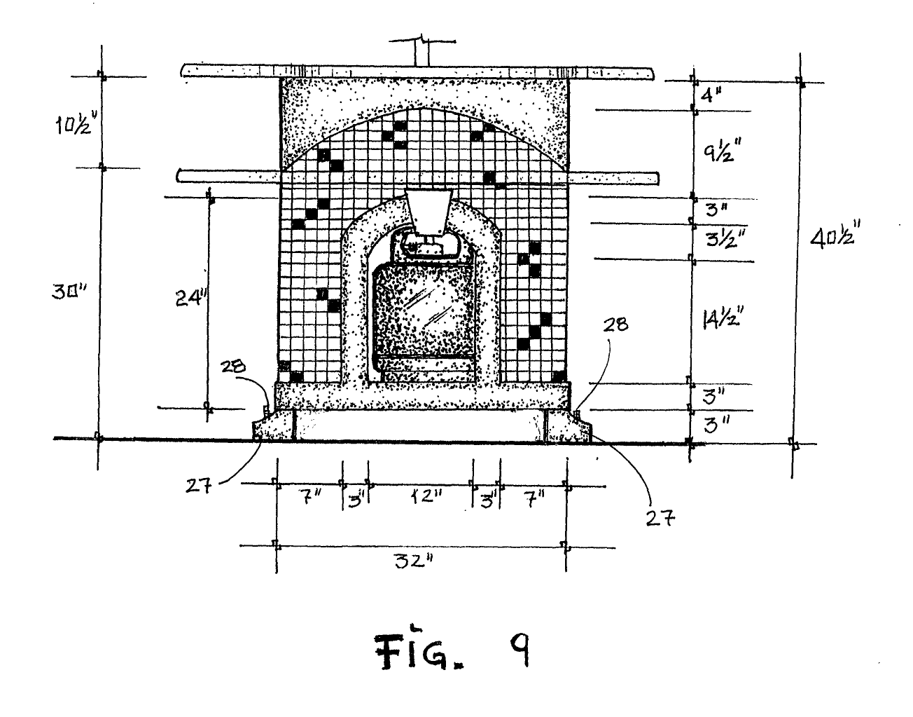

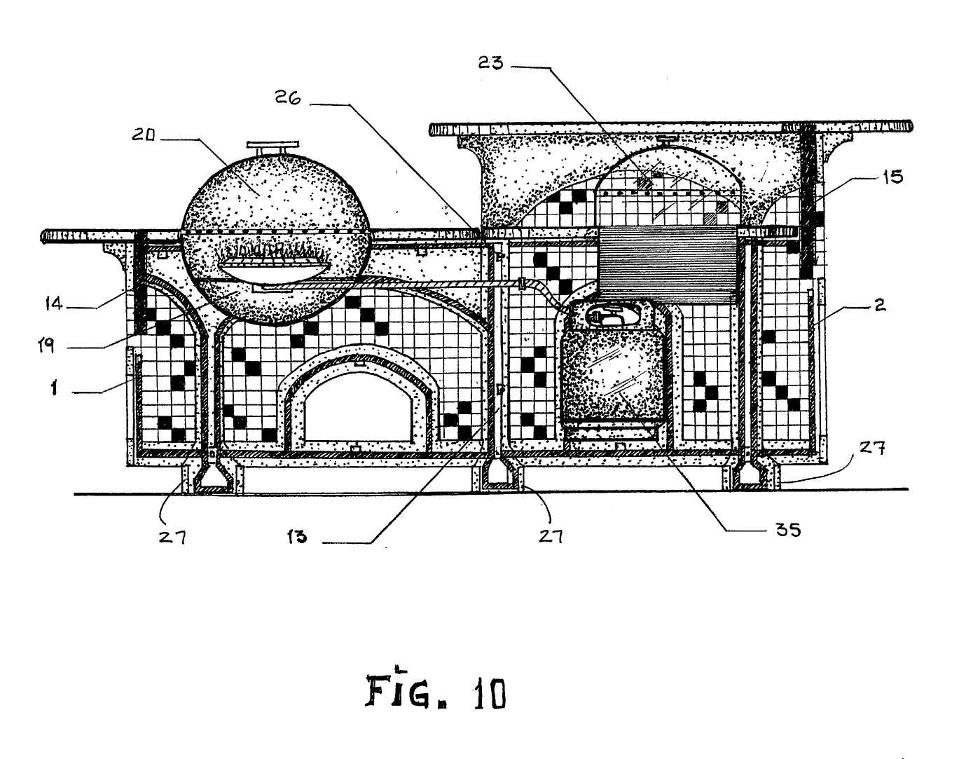

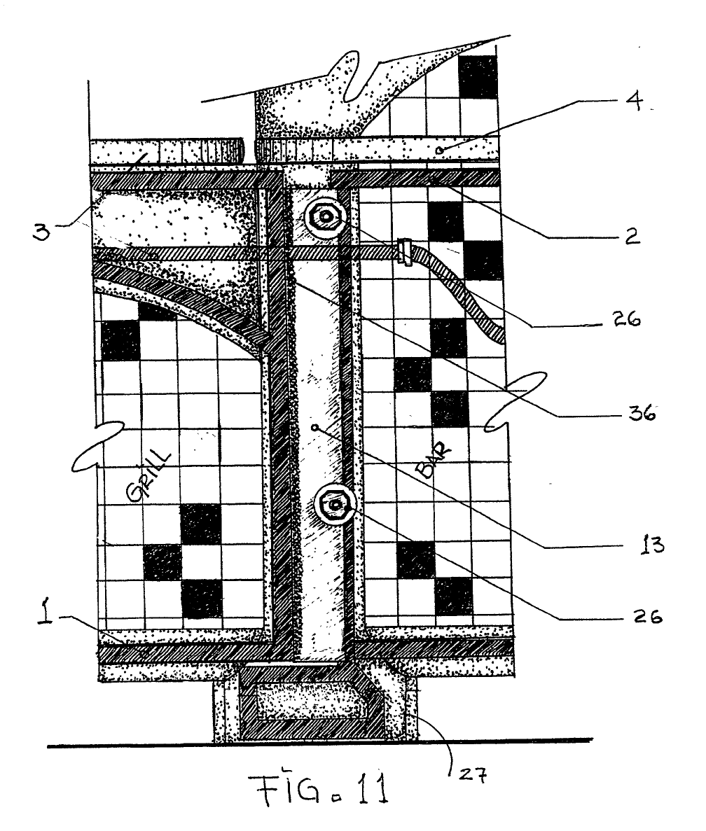

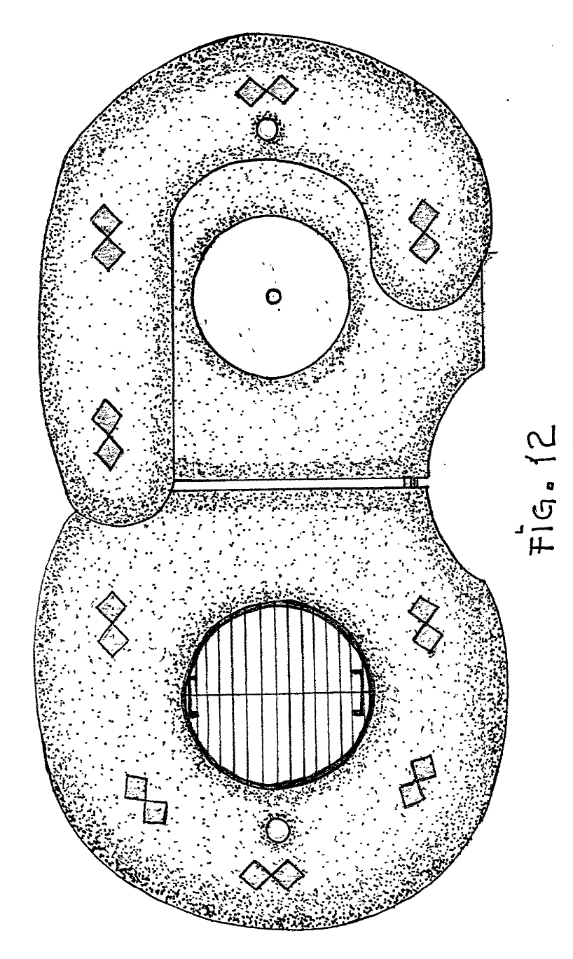

FIGS. 1 to 14

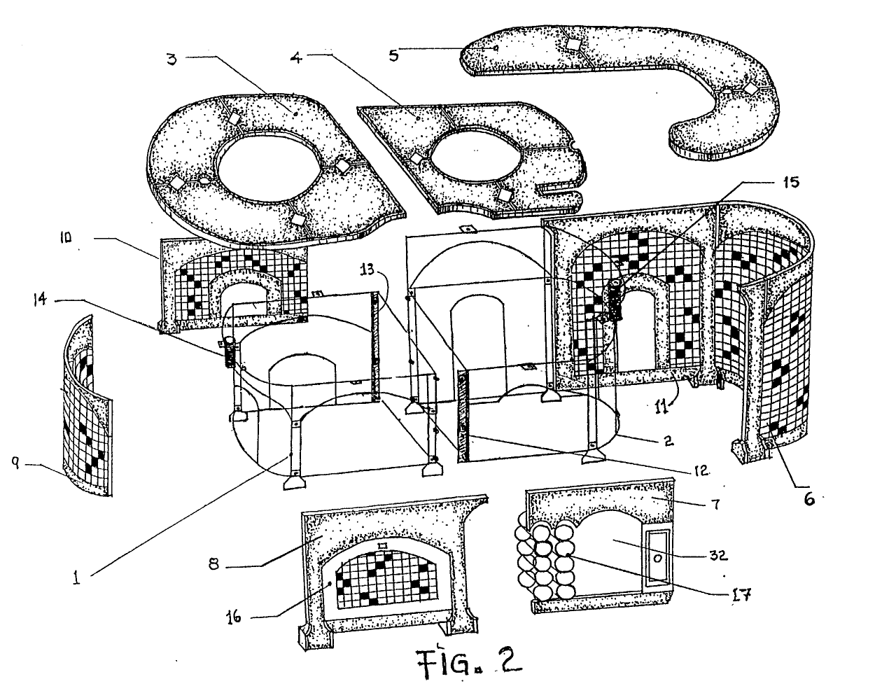

The isometric figure of a typical finished apparatus is shown in FIG. 1. (Umbrellas are not shown in the figure.) The apparatus is comprised of 11 major components as shown in the exploded view in FIG. 2, 1 thru 11, which will be described in detail as follows.

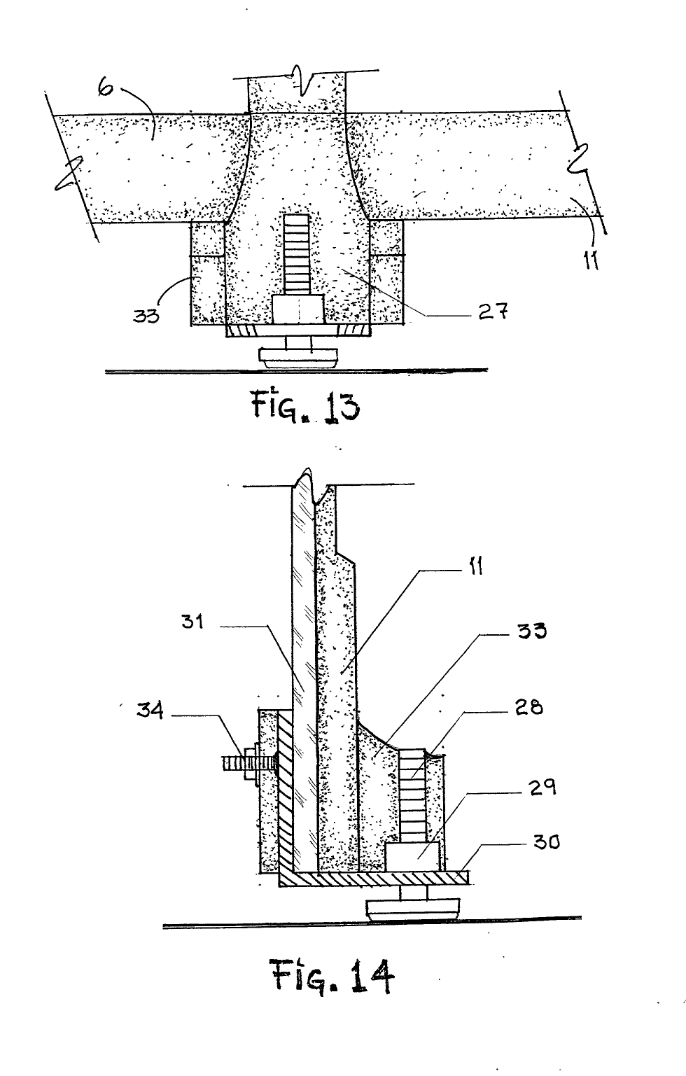

As FIG. 2 shows, the apparatus comprises of two skeletal metallic frame structures, 1 and 2, which divide the structure in two halves. All of the main components are fasten to these two structures. The two skeletal frame structures are made of welded half-inch solid square bar. Each skeletal frame has two edges that join the two structures, 12 and 13, one side of each joint has a 1½ inches by ¼ inches metal plate with two holes welded to the frame structure 36, the other side has two ⅜ by 1½ inches bolts which mesh with the holes and are affixed with washers and nuts 26. These bolts and nuts hold the two main structures together. Additionally each one of the two principal frames, 1 and 2, has an umbrella holder, 14 and 15, welded to it. The umbrella holders are made of 1½ inch diameter pipe, and are 12 inches long. Six legs 27, FIG. 13, support the skeletal frames 1 and 2. FIG. 13 shows a typical leg. The leg 27 is composed of an adjustable bolt 28 that is used to adjust the height of the leg depending on the surface on which the apparatus is place. The bolt 28 is fixed by a nut 29 that is welded to a 3 by 3 in. L-shaped metal, 3 in. long 30, and is itself welded to the main skeletal frame. A resin cover 33 held by a bolt and nut 34 encases the leg 27.

The six faceplates, 6 thru 11, are preferably made of a mixture of resin and stone, cast in molds, to which small metal plates are embedded to make a welding surface. Faceplates 8, 9 and 10 are welded to metal frame 1, and faceplates 6, 7 and 11 are welded to metal frame 2. Faceplate 8 has a built in service door 16 for access to the interior of the apparatus. Faceplate 7 has a built in wine rack 17 and opening for access 32 to the interior where a gas tank 35 may be place if the option of use of a gas grill has been elected.

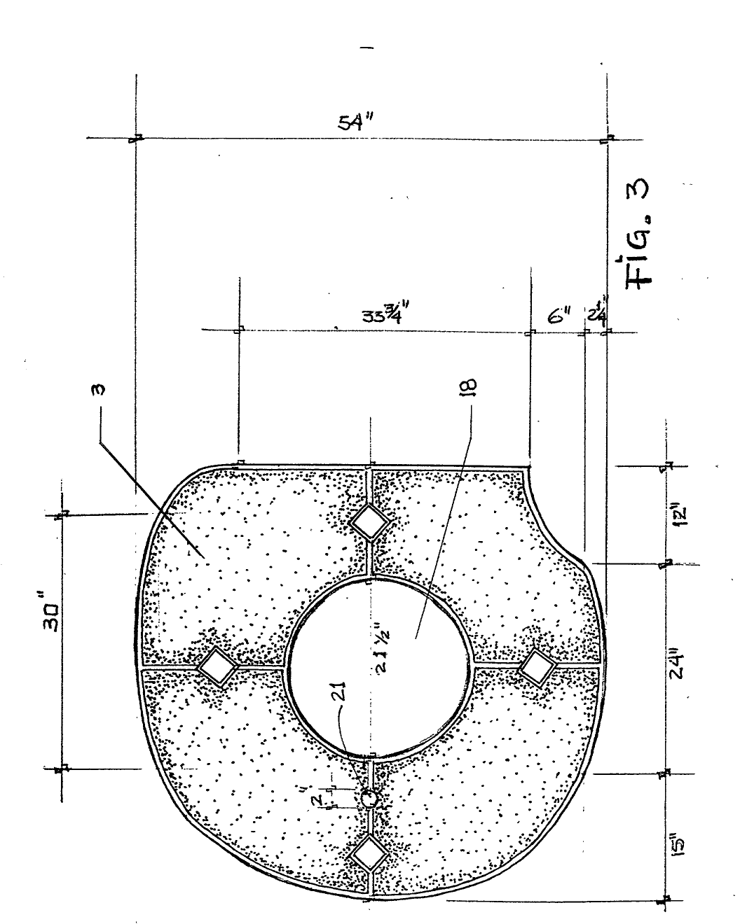

The apparatus has 3 tabletops, 3, 4 and 5, made preferably of a mixture of resin and stone, cast in molds, to these tabletops bolts are embedded to provide a connection to frames 1 and 2. Tabletop 3, FIG. 3 has a 21½ inch hole 18 to hold a grill bowl 19. Tabletop 3 also has a 2-inch hole 21 for use with umbrella stand 14. Tabletop 4 has a 17-inch hole 22 for placement of a cooler 23, and a cutout 24, 2 inches in diameter to be used with umbrella holder 15. Tabletop 5 also has a 2-inch hole 25, for use with umbrella holder 15. Tabletop 3 is attached to frame 1 with the embedded bolts and nuts. Tabletop 4 and 5 are attached to frame 2 with embedded bolts and tightened with nuts.

Operation

FIG. 1

The bar-grill-cooler has a section that is used for cooking meals by the use of a barbecuing grill 19 on tabletop 3. Either a gas burner or regular charcoal may be use for heating. An ice container is provided on tabletop 4 with a cover, which acts as a cooler where drinks may be placed for chilling and are within reach. The apparatus also provides a table bar where people may sit by the use of bar stools. A storage space is provided under the grill and cooler, the grill storage is accessed thru a door 16 and the storage area under the cooler is accessed thru an opening 32 on faceplate 7. The storage area 32 also has a built in wine rack 17 for bottle storage.

People may sit all around the apparatus without wasting a single side, and they will be covered by the shade of two umbrellas place at both umbrella holders 14 and 15 at the extremes of the apparatus.

Conclusion, Ramifications, and Scope

The reader can see that the bar-grill-cooler of this invention can have multiple functions in a single apparatus. It barbecues and provides an eating table for guests as well as a cooler for drinks. People may sit around the apparatus bringing a more intimate environment to gatherings. Furthermore, the bar-grill-cooler has the additional advantages in that

It permits the use of various functions without the need to stop using one of them and disassembling and reassembling;

It has storage space for it's own accessories and for barbecuing utensils;

It has ventilation of all its interior spaces that prevents the accumulation of gases if a gas tank is been used;

It is easy and simple to handle and assemble;

It allows for people join the gathering from any point of the apparatus;

It has a welded metallic frame structure;

It has a design which allows for any number of aesthetic designs to be placed on the faceplates, therefore giving the ability to have different original designs available;

It is well balanced in size and proportion, gives an innovative addition to any backyard or patio and enhances its appearance.

Although the description above contains many specificities, these should not be construed as limiting the scope of the invention but as merely providing illustrations of some of the presently preferred embodiments of this invention. For example, the finishes on the faceplates may have one of many designs.

I claim:

1. An article of patio furniture combining a table, bar, grill and cooler for the preparation of food, comprising:
a) A cooking barbecue grill and bowl and a container for holding ice surrounded by tabletops and a bar of sufficient size to accommodate sitting persons around it
b) Vertical faceplates with aesthetic designs
c) A welded metallic frame support structure for attachment of all components
d) Adjustable legs

2. The structure of claim 1, wherein said tabletops and faceplates are made of a resin and stone mixture and are made by casting the mixture in molds.

3. The structure of claim 1, wherein said welded metallic frame structure is made of welded structural iron.

4. The structure of claim 2, wherein said faceplates can have different type of finishes and aesthetic designs.

5. The structure of claim 1, wherein said adjustable legs are made of structural iron comprising of a bolt for adjusting the height of the leg therefore accommodating the structure to uneven surfaces.

6. An article of patio furniture combining a table, bar, grill and cooler for the preparation of food, comprising:
a) A gas or charcoal grill and cooler surrounded by tabletops and a table bar of sufficient size to accommodate sitting persons around it
b) Vertical faceplates with designable aesthetic patterns
c) A welded metallic frame which acts as a skeletal structure for screwing and welding of all faceplates and tabletops
d) Leveling support members

7. The structure of claim 6, wherein said tabletops and faceplates are made of a resin and stone mixture and are made by casting the mixture in molds.

8. The structure of claim 6, wherein said welded metallic frame is made of welded structural iron.

9. The structure of claim 7, wherein said faceplates can have different type of finishes and aesthetic designs.

10. The structure of claim 6, wherein said leveling support members are made of structural iron comprising of a bolt that runs on a nut welded to the iron structure and is used for adjusting the height of the leg and is surrounded by a resin and stone mixture cover.
